(19) United States
(12) Patent Application Publication
(10) Pub. No.: US 2017/0361350 A1
(43) Pub. Date: Dec. 21, 2017

(54) PARTICULATE SPRAY BOOTH HAVING A SEALED PARTICULATE SPRAY DEVICE BOOTH WALL OPENING

(71) Applicant: NORDSON CORPORATION, Westlake, OH (US)

(72) Inventors: Jeffery E. Dailidas, Barrington, IL (US); Greg Dawson, Niceville, FL (US); Joseph G. Schroeder, North Royalton, OH (US); Douglas C. Bloomfield, North Olmstead, OH (US)

(21) Appl. No.: 15/184,176

(22) Filed: Jun. 16, 2016

(51) Int. Cl. B05B 15/12; B05B 7/14

(52) U.S. Cl. CPC B05B 15/1229; B05B 7/1486; B05B 15/1214

(57) ABSTRACT

A particulate spray booth having a sealed particulate spray device booth wall opening is disclosed. The powder coating material spray system may include a booth comprising a ceiling, a floor, and side walls defining an interior of the booth, wherein the booth defines an opening from the interior of the booth to an exterior of the booth. The system may further include a powder spray device received through the opening, the powder spray device comprising a body and a nozzle through which powder coating material is sprayed into the interior of the booth, wherein the nozzle and at least part of the body are disposed in the interior of the booth. The system may further include a flexible boot element having a proximal end and a distal end opposite the proximal end, the proximal end attached to a periphery of the opening to form a first seal and the distal end attached to the at least part of the body of the powder spray device disposed in the interior of the booth to form a second seal.

### TECHNICAL FIELD

This application relates to a particulate spray system, and more particularly to a particulate spray system with a particulate spray booth having a sealed particulate spray device booth wall opening to increase the efficiency of the particulate spray system by requiring less energy to exhaust powder overspray.

### BACKGROUND

The present disclosure relates to particulate spray systems having one or more particulate spray devices that spray particulate materials onto workpieces inside the spray booth of the particulate spray system, wherein at least some of the particulate material must be collected from the spray booth and recovered for reuse. The particular spray device could spray particular materials onto the workpiece, such as for sandblasting the workpiece, for example. In a particular preferred embodiment, the particulate spray device could spray powder coating material in a powder coating material spray booth.

Powder coating material booths typically include openings in the booth walls to allow for powder spray devices to pass through and into the interior of the booth. To collect the excess powder following coating of an article or during a color change procedure, suction means are typically used. However, the openings in the booth walls can be large to allow for manual or automatic spray coating devices, resulting in the escape of overspray powder and requiring a tremendous amount of energy to power the suction means. To address this issue, a solution is needed to seal the openings to prevent the escape of overspray powder and more efficiently create a vacuum condition within the booth. Accordingly, this seal solution will result in a decreased overall cost of use of the booth, whether the booth is used to spray powder coating material or particulate material such as sandblasting materials.

### SUMMARY

In one preferred embodiment, the particulate spray system is a powder coating material spray system having a powder coating spray device surrounded by a flexible boot element. In one aspect, a powder coating material spray system may include a booth comprising a ceiling, a floor, and side walls defining an interior of the booth, wherein the booth defines an opening from the interior of the booth to an exterior of the booth. The system may further include a powder spray device received through the opening, the powder spray device comprising a body and a nozzle through which powder coating material is sprayed into the interior of the booth, wherein the nozzle and at least part of the body are disposed in the interior of the booth. The system may further include a flexible boot element having a proximal end and a distal end opposite the proximal end, the proximal end attached to a periphery of the opening to form a first seal and the distal end attached to the at least part of the body of the powder spray device disposed in the interior of the booth to form a second seal.

In an aspect, the powder coating material spray system may further include a powder recovery system comprising an overspray intake communicating with the interior of the booth and a suction means for drawing overspray powder from the interior of the booth into the overspray intake. The powder spray device may be moved by a robotic arm situated on the exterior of the booth.

In an aspect, the boot element may form a conical shape tapering from a first diameter at the proximal end to a second diameter at the distal end, the first diameter being greater than the second diameter. For example, the first diameter may be at least twice the second diameter.

In another aspect, the first seal and the second seal may each be hermetic seals.

In an aspect, at least one of the proximal end and the distal end of the boot element may be configured to attach, respectively, to the periphery of the opening or the body of the powder spray device via a lever-operated clamp, an elastic band, a zipper, one or more clips, or a hook-and-loop system. In an aspect including a zipper, the boot element may comprise a flap covering the zipper.

In another aspect, the distal end of the boot element may be configured to attach to the body of the powder spray device via a rotatable bearing. In such an aspect, the nozzle may include an outlet through which the powder coating material is sprayed, the outlet configured as an elongate slit.

In yet another aspect, the boot element may comprise at least one of polyurethane, neoprene, silicone, and latex.

In another preferred embodiment, the particulate spray system is a system for spraying sandblasting materials onto a workpiece inside the booth. The spray device is surrounded by a flexible boot element. In one aspect, the spray system may include a booth comprising a ceiling, a floor, and side walls defining an interior of the booth, wherein the booth defines an opening from the interior of the booth to an exterior of the booth. The system may further include a spray device received through the opening, the spray device comprising a body and a nozzle through which particulate material is sprayed into the interior of the booth, wherein the nozzle and at least part of the body are disposed in the interior of the booth. The system may further include a flexible boot element having a proximal end and a distal end opposite the proximal end, the proximal end attached to a periphery of the opening to form a first seal and the distal end attached to the at least part of the body of the spray device disposed in the interior of the booth to form a second seal.

In an aspect, the spray system may further include a recovery system comprising an overspray intake communicating with the interior of the booth and a suction means for drawing particulate material that has already been sprayed from the spray device from the interior of the booth into the exhaust. The spray device may be moved by a robotic arm situated on the exterior of the booth.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 is a perspective view partly cut away of a powder spray booth in accordance with an embodiment.

FIG. 2 is a side view of the powder spray booth of FIG. 1 and an associated robotic arm in accordance with an embodiment.

FIG. 3 is a side view of a powder spray booth and an associated powder recovery system.

FIG. 4 is a close-up view of a boot element disposed on a spray device in accordance with an embodiment.

FIG. 5 is a close-up view of a boot element disposed on a spray device in accordance with an embodiment.

FIG. 6 is a perspective view of a boot element in accordance with an embodiment.

### DETAILED DESCRIPTION

Although this disclosure details a powder coating material spray booth, it is understood that the teachings below can be applied to other particulate material spraying systems, such as a system for spraying sandblasting materials onto workpieces within the booth, such as to remove coatings from the workpieces or clean them.

Disclosed herein are systems and apparatus for providing a flexible boot element for use in conjunction with a movable spray device of a substantially sealed powder spray booth. The boot element may be attached to both the spray device and a wall of the powder spray booth such that the boot element provides a seal between the interior of the powder spray booth and the exterior of the powder spray booth while still allowing sufficiently free movement of the spray device to execute its spray function. For example, the boot element may be configured as a generally conical formation in which the larger end of the boot element is sealed to the opening of the powder spray booth through which the spray device projects and the smaller end of the boot element is sealed to the spray device.

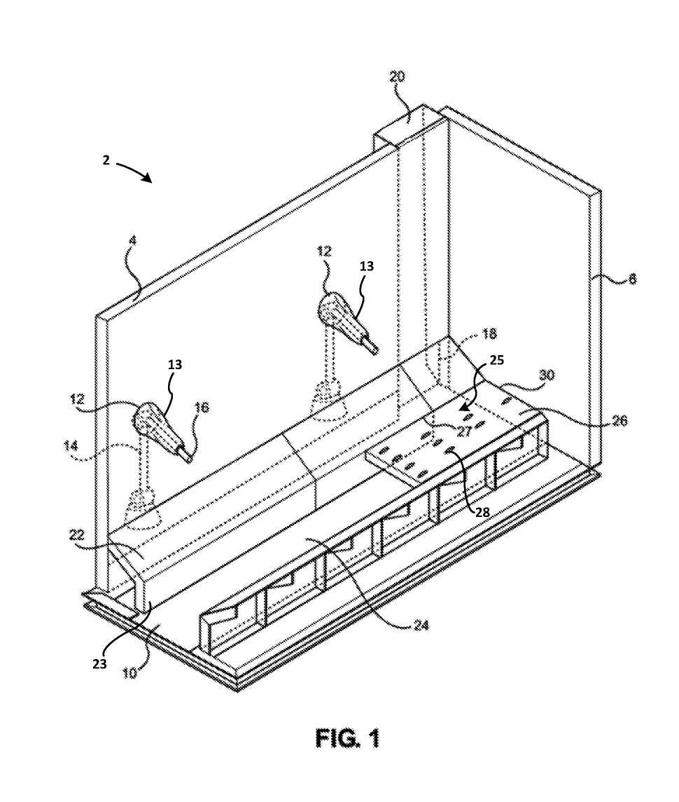

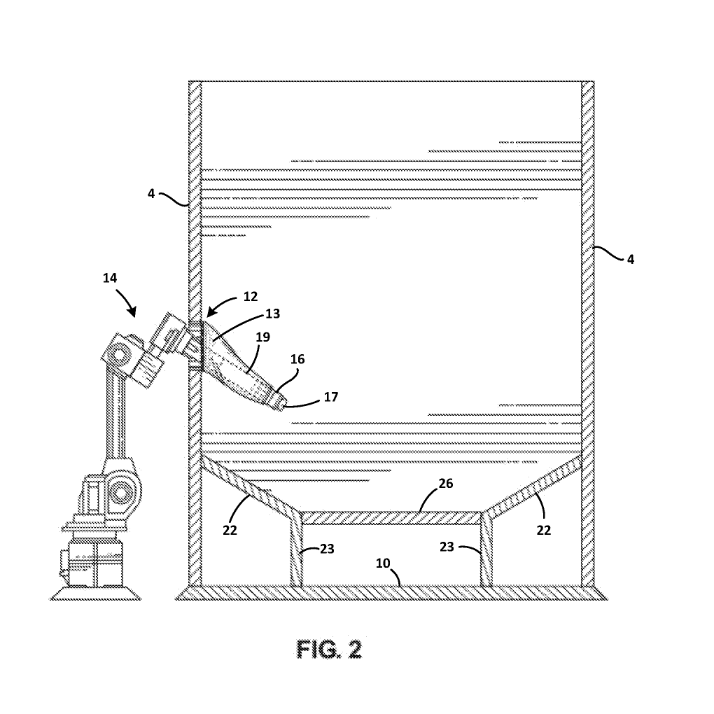

FIGS. 1 and 2 depict an illustrative powder spray booth 2 with ceiling (not shown), side walls 4, end walls 6, and a floor 10 defining an interior and an exterior of the spray booth 2. While the spray booth 2 is depicted in FIG. 1 without the foreground side wall 4 and end wall 6, it will be understood that the interior of the spray booth 2 is substantially sealed from the exterior of the spray booth 2. The spray booth 2 may further be configured with a conveyor (not shown) from which objects may be suspended and conveyed through the interior of the spray booth 2 for coating with powder by one or more spray devices 16.

In some aspects, the ceiling, side walls 4, end walls 6, and/or floor 10 of the spray booth 2 may be made from a non-conducting material, such as plastic. By using plastic or other non-conductive material, the powder sprayed from the spray device 16, which in some applications may be electrostatically charged, will have a reduced tendency to adhere to the surfaces of the spray booth 2. Accordingly, the powder not adhering to the spray object (i.e., overspray powder) will fall under gravity and collect on the floor 10 or other lower portions of the spray booth 2. For durability, the floor 10 and/or surfaces on which an operator will walk may instead be made of stainless steel.

One or more openings 12 may be defined in the side wall 4 (or other surface defining the interior of the spray booth 2) to allow a respective spray device 16 to project into the interior of the spray booth 2. The spray device 16 may be controlled by a human operator (not shown) or by a robotic arm 14 (as shown in FIGS. 1 and 2). The robotic arm 14 may control the various movements of the spray device 16. For example, the robotic arm 14 may move the spray device 16 horizontally and/or vertically within the confines of the opening 12. Further, the robotic arm 14 may also adjust the vertical and/or horizontal angle at which the spray device 16 is tilted. Further still, the robotic arm 14 may also move the spray device 16 in the direction into and/or out of the spray booth 2. Finally, the robotic arm 14 may rotate the spray device 16 about an elongate axis of the spray device 16.

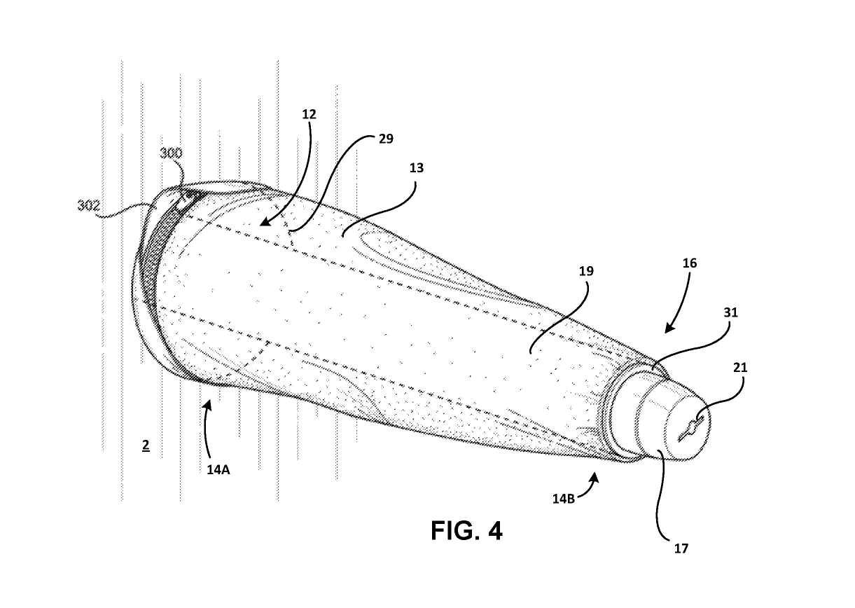

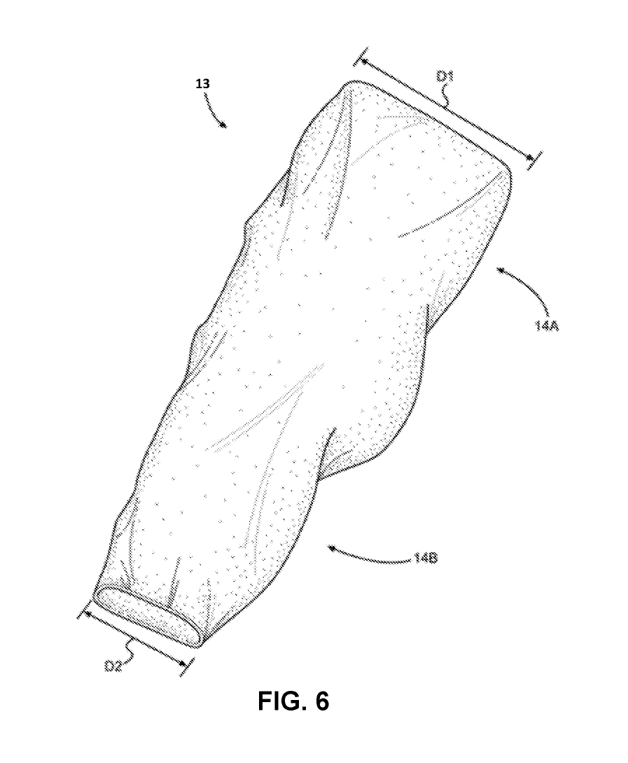

The spray device 16, or portion thereof, projecting into the interior of the spray booth 2 is surrounded by a boot element 13 configured to attach to the spray device 16 and the periphery of the opening 12 to seal the interior of the spray booth 2. The seal provided by the boot element 13 may serve to prevent airborne overspray powder from exiting the interior of the spray booth 2 and potentially contaminating the exterior, the robotic arm 14, and/or human operators. Further, the seal provided by the boot element 13 may also facilitate a suction and/or airflow created by a powder recovery system 34. The spray device 16 and the boot element 13 will be described in additional detail with reference to FIGS. 4-6.

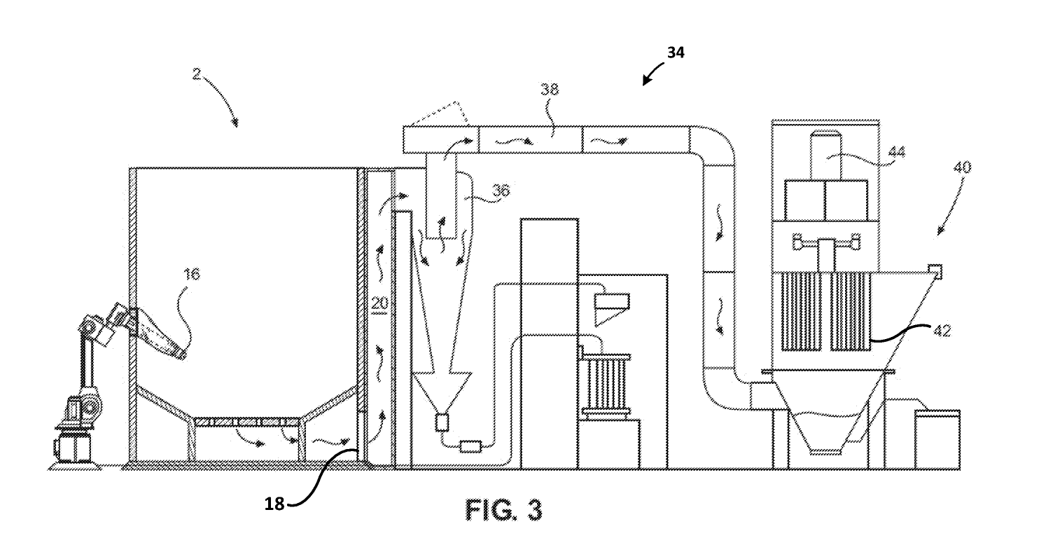

With additional attention to FIG. 3, the spray booth 2 is provided with the powder recovery system 34 to remove and recover overspray powder that did not adhere to the spray object. By way of example, the spray booth 2 is configured with an overspray intake 18 located in a corner of the spray booth 2. A current of exhaust air is provided within the spray booth 2 and into the overspray intake 18 to draw in overspray powder. Rising there above is a duct 20 which leads to additional components of the powder recovery system 34. Although the overspray intake 18 and the duct 20 are depicted in FIG. 1 as being positioned on the same side of the spray booth 2 as the opening 12 and the spray device 16, the configuration of the spray booth 2 is not so limited. For example, the overspray intake 18 and the duct 20 may be positioned on an opposite side of the spray booth 2 as the opening 12 and the spray device 16, as depicted in FIG. 3.

The powder recovery system 34 may include a cyclone separator 36 that is connected to the duct 20. In the cyclone separator 36, the overspray powder is separated from the air-powder mixture drawn from the spray booth 2 via the duct 20. Under the influence of centrifugal and gravitational forces, the overspray powder falls to the bottom of the cyclone separator 36 where it may be collected in a container for re-use. The exhaust air from the cyclone separator 36 which, during normal operation of the spray booth 2 contains only a small amount of overspray powder, passes through a connector pipe 38 to a powder filter unit 40, which is sometimes called an after filter. The powder filter unit 40 includes therein one or more filter elements, such as one or more filter cartridges 42, which filter out the remaining overspray powder in the exhaust air from the cyclone separator 36. The cleaned exhaust air is then drawn out of the filter unit 40 and discharged into the atmosphere by a fan 44 mounted at the top of the filter unit 40. Powder collected in the filter unit 40 may also be collected for re-use.

It will be appreciated that the action of the fan 44 provides the current of exhaust air within the spray booth 2 to draw the overspray powder into the overspray intake 18. The larger the area of any openings in the spray booth 2 (e.g., an unsealed opening 12 for the spray device 16, an opening of a conveyor slot, etc.), the greater the size of the fan 44 required to pull sufficient air through those openings to keep the overspray powder within the spray booth 2 and collect it in the powder recovery system 34. In determining the size of the fan 44, the width and length of the conveyor slot at the top of the spray booth 2, the size of the openings at the entrance and exit of the spray booth 2 and/or the size of all openings in the sidewalls of the booth, such as the openings 12 for the spray guns 16 to project within the spray booth 2, must all be considered in order to achieve the desired CFM (cubic feet per minute) air flow rate into the spray booth 2 through these openings. By using the boot element 13 to provide a seal to the opening 12 through which the spray device 16 is inserted into the spray booth 2, this large opening into the spray booth 2 can be removed from the calculation of the CFM air flow rate required to pull enough air into the spray booth 2 to keep the overspray powder in the spray booth 2 and collect overspray powder in the powder recovery system 34, resulting in a lower required CFM air flow rate than would be the case if the opening 12 were not sealed. This lower CFM air flow rate translates into a smaller fan 44 that can be provided to maintain the necessary airflow through all the spray booth openings to maintain overspray powder within the spray booth 2 and collect it in the powder recovery system 34. Accordingly, by reducing the size of the fan 44 in accordance with the teaching of this disclosure, energy costs can also be reduced as well as the cost of the fan 44.

Referring again to FIGS. 1 and 2, the floor 10 of the spray booth 2 is configured with two sloping portions 22 on either side thereof. The upper edges of the sloping portions 22 are flush with the respective side wall 4. The lower edges of the sloping portions 22 are set apart from one another to define a trough 24 therebetween to collect overspray powder descending from the sloping portions 22. Vertical walls 23 extending from the lower edges of the sloping portions 22 to the floor 10 further define the trough 24. A cutaway 25, corresponding with the location of the overspray intake 18, is included in the vertical wall 23 to provide a connection between the overspray intake 18 and the trough 24 and thus also the rest of the interior of the spray booth 2.

A diverter plate 26 is positioned in the trough 24 at the end where the overspray intake 18 is located and extends from that end. The length of the diverter plate 26 is preferably equal to the distance from the end of the spray booth 2 to the center line of the first spray device 16 relative to that end of the trough 24, plus an offset. The offset may suitably be of the order of 200 mm. The diverter plate 26 is suitably spaced from the lower edges of the sloping portions 22 to define slots 27 therebetween. The diverter plate 26 is detachably supported on its underside by tabs (not shown) affixed to the lower edges of the sloping portions 22 and is mounted to the end wall 6 via one or more hinges 30 to allow it to be pivoted up and against the end wall 6. The diverter plate 26 is configured with a pattern of holes 28 therein. The holes 28 are elongate in the lengthwise direction of the diverter plate 26 and hence also the spray booth 2.

In use, one or more of the spray devices 16 are employed to apply powder to objects passing through the spray booth 2. Airborne overspray powder is extracted from the interior of the spray booth 2 on the current of exhaust air produced by the fan 44 of the powder recovery system 34 via the overspray intake 18 and duct 20. Overspray powder which falls out of the transport air provided by the powder recovery system 34 will be deposited on the floor 10 of the spray booth 2 and so on the sloping portions 22, the bottom of the trough 24, and the diverter plate 26. The flow of exhaust air caused by the powder recovery system 34 along the trough 24 will tend to draw deposited overspray powder on the upper surface of the diverter plate 26 down into the trough 24 there below either through the holes 28 or the slots 27 between the sloping portions 22 and the diverter plate 26.

The cleaning operation which is performed, such as when the color of the powder is to be changed, will now be described. The spray devices 16 are shut off and any access points to the interior of the spray booth are closed or sealed off. The diverter plate 26 is pivoted up against the adjacent end wall 6. An operator, preferably using an air hose, begins at the opposite end of the spray booth 2 from the duct 20 and moves along the spray booth 2 blowing the deposited overspray powder which remains therein from all wall and floor surfaces and the surfaces of the diverter plate 26, the duct 20, and the overspray intake 18. As the powder is blown off of the surfaces of the spray booth 2, it is drawn into the duct 20 by the current of exhaust air provided via the overspray intake 18.

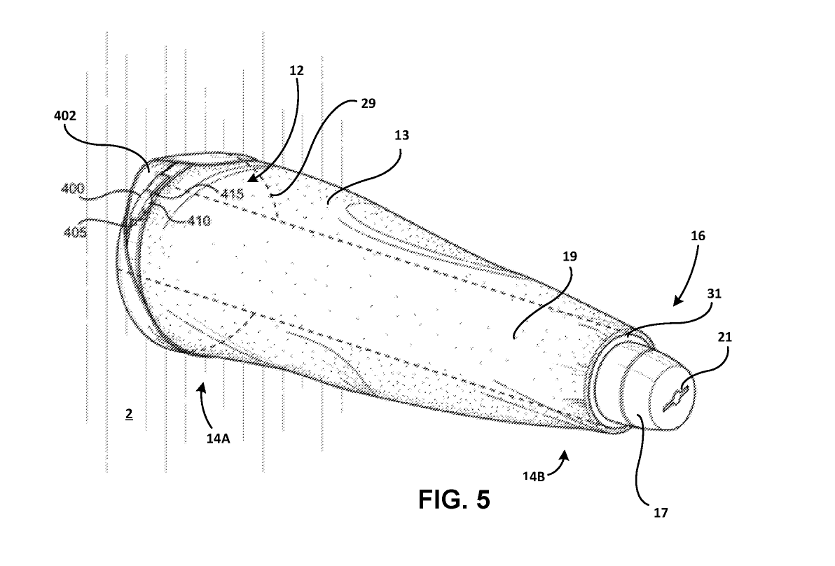

With additional reference to FIGS. 4 and 5, the spray device 16, or portion thereof projecting through the opening 12, is situated within the boot element 13. In particular, an elongate body 19 of the spray device 16 substantially projects through the opening 12 and, therefore, also through the boot element 13. A nozzle 17 is disposed at one end of the elongate body 19 of the spray device 16. The nozzle 17 includes an outlet 21 through which powder is sprayed. In some aspects, such as depicted in FIGS. 4 and 5, the outlet 21 may be configured as an elongate slit such that the spray pattern therefrom is similarly elongated (as opposed to a circular spray pattern). In such an aspect, the spray from the outlet 21 would be affected by the rotational position of the spray device 16.

The boot element 13 depicted in FIGS. 4-6 is configured in a generally conical or frusto-conical shape, but may alternatively be formed in a hemispherical, frusto-hemispherical, pyramidal, or frusto-pyramidal shape in other aspects. Accordingly, the boot element 13 has a proximal end 14A with a diameter (or width) D1 and a distal end 14B, opposite the proximal end 14A, with a diameter (or width) D2. The proximal end 14A is coupled with a periphery 29 of the opening 12 in the side wall 4, such as the interior of the side wall 4 surrounding the opening 12. The distal end 14B is coupled with the spray device 16, such as around the circumference of the elongate body 19 near the nozzle 17. Since the opening 12 in the side wall 4 will typically be sized to allow sufficient movement of the spray device 16, the diameter D1 of the proximal end 14A of the boot element 13 will also typically be greater than the diameter D2 of the distal end 14B of the boot element 13. For example, the diameter D1 of the proximal end 14A may be at least twice as wide as the diameter D2 of the distal end 14B.

To provide a seal of the interior of the spray booth 2, the proximal end 14A of the boot element 13 is coupled with the periphery 29 of the opening 12 in a manner that provides a substantially air-tight seal with the periphery 29 of the opening 12. Advantageously, the proximal end 14A of the boot element 13 may also be releasably coupled with the periphery 29 of the opening 12 to facilitate easy decoupling of the boot element 13 and/or the spray device 16 with the side wall 4. Further, the distal end 14B of the boot element 13 is coupled with the spray device 16 to similarly provide a substantially air-tight seal with the spray device 16. The coupling of the distal end 14B of the boot element 13 and the spray device 16 may also be accomplished in a manner that allows easy release.

As shown in FIG. 4, the proximal end 14A of the boot element 13 and/or the periphery 29 of the opening 12 may be configured with a zipper 300 to releasably couple the proximal end 14A and the periphery 29 of the opening 12. The zipper 300 is configured with a flap 302 that is used to cover the teeth and pull of the zipper 300. The flap 302 may serve to enhance the seal provided by the zipper 300 and/or prevent overspray powder from clogging the zipper 300. Although not depicted as such in FIG. 4, the distal end 14B of the boot element 13 and/or the spray device 16 may also be configured with a zipper.

As depicted in FIG. 5, the proximal end 14A of the boot element 13 may be configured with a lever-operated clamp 400 to releasably couple the proximal end 14A of the boot element 13 with the periphery 29 of the opening 12 in the side wall 4. The clamp 400 utilizes a lever 405 that engages a baseplate 410, via a hinge 415, to couple the proximal end 14A to the periphery 29 of the opening 12. To release the proximal end 14A from the periphery 29 of the opening 12, the lever 405 is disengaged from the baseplate 410. A flap 402 covering the clamp 400 may also be used to enhance the seal provided by the clamp 400 and protect the clamp 400 from overspray powder. The distal end 14B of the boot element 13 may be similarly coupled with the spray device 16 using a clamp.

Other than the aforementioned zipper 300 and clamp 400, other types of connectors for coupling the boot element 13 with the periphery 29 of the opening 12 and/or the spray device 16 include clips, snaps, elastic band, or hook-and-loop fasteners.

The boot element 13 may be formed of any flexible material suitable to allow movement of the spray device 16 and to provide a substantially air-tight seal of the interior of the spray booth 2 from the exterior of the spray booth 2. Exemplary materials of which the boot element 13 may be constructed include tight-woven fabric, polyurethane, neoprene, silicone, and/or latex.

In one aspect, depicted in FIGS. 4 and 5, the distal end 14B of the boot element 13 is rotatably coupled with the spray device 16, such as via a rotatable bearing 31. The bearing 31 allows the spray device 16 to be rotated about an axis of the spray device 16, such as by the robotic arm 14, without entangling or twisting the boot element 13 with the spray device 16. It will be appreciated that the bearing 31 is also hermetically sealed so that exterior of the spray booth 2 remains sealed from the exterior of the spray booth 2.

It will be apparent to those skilled in the art that various modifications and variations may be made without departing from the scope or spirit. Other implementations will be apparent to those skilled in the art from consideration of the specification and practice disclosed herein. It is intended that the specification and examples be considered as exemplary only, with a true scope and spirit being indicated by the following claims.

What is claimed is:

1. A powder coating material spray system, the system comprising:
a booth comprising a ceiling, a floor, and side walls defining an interior of the booth, wherein the booth defines an opening from the interior of the booth to an exterior of the booth;
a powder spray device received through the opening, the powder spray device comprising a body and a nozzle through which powder coating material is sprayed into the interior of the booth, wherein the nozzle and at least part of the body are disposed in the interior of the booth; and
a flexible boot element having a proximal end and a distal end opposite the proximal end, the proximal end attached to a periphery of the opening to form a first seal and the distal end attached to the at least part of the body of the powder spray device disposed in the interior of the booth to form a second seal.

2. The system of claim 1, further comprising:
a powder recovery system comprising an overspray intake communicating with the interior of the booth and a vacuum for drawing overspray powder from the interior of the booth into the overspray intake.

3. The system of claim 2, wherein the powder spray device is moved by a robotic arm situated on the exterior of the booth.

4. The system of claim 1, wherein the boot element forms a conical shape tapering from a first diameter at the proximal end to a second diameter at the distal end, the first diameter being greater than the second diameter.

5. The system of claim 4, wherein the first diameter is at least twice the second diameter.

6. The system of claim 1, wherein the boot element forms a pyramidal shape tapering from a first width at the proximal end to a second width at the distal end, the first width being greater than the second width.

7. The system of claim 1, wherein the first seal and the second seal are each hermetic seals.

8. The system of claim 7, wherein at least one of the proximal end and the distal end of the boot element is configured to attach, respectively, to the periphery of the opening or the body of the powder spray device via a lever-operated clamp.

9. The system of claim 7, wherein at least one of the proximal end and the distal end of the boot element is configured to attach, respectively, to the periphery of the opening or the body of the powder spray device via an elastic band.

10. The system of claim 1, wherein at least one of the proximal end and the distal end of the boot element is configured to releasably attach, respectively, to the periphery of the opening or the body of the powder spray device.

11. The system of claim 10, wherein at least one of the proximal end and the distal end of the boot element is configured to attach, respectively, to the periphery of the opening or the body of the powder spray device via a zipper.

12. The system of claim 11, wherein the boot element comprises a flap covering the zipper.

13. The system of claim 10, wherein at least one of the proximal end and the distal end of the boot element is configured to attach, respectively, to the periphery of the opening or the body of the powder spray device via one or more clips.

14. The system of claim 10, wherein at least one of the proximal end and the distal end of the boot element is configured to attach, respectively, to the periphery of the opening or the body of the powder spray device via a hook-and-loop system.

15. The system of claim 1, wherein the distal end of the boot element is configured to attach to the body of the powder spray device via a rotatable bearing.

16. The system of claim 15, wherein the nozzle includes an outlet through which the powder coating material is sprayed, the outlet configured as an elongate slit.

17. The system of claim 1, wherein the boot element comprises at least one of polyurethane, neoprene, silicone, and latex.

18. The system of claim 1, further comprising:
a particulate material recovery system comprising an overspray intake communicating with the interior of the booth and vacuum for drawing overspray particulate material from the interior of the booth into the overspray intake.

19. The system of claim 18, wherein the spray device is moved by a robotic arm situated on the exterior of the booth.

20. A particulate spraying system, the system comprising:
a booth comprising a ceiling, a floor, and side walls defining an interior of the booth, wherein the booth defines an opening from the interior of the booth to an exterior of the booth;
a particulate material spray device received through the opening, the spray device comprising a body and a nozzle through which particulate material is sprayed into the interior of the booth onto a workpiece within the booth, wherein the nozzle and at least part of the body are disposed in the interior of the booth; and
a flexible boot element having a proximal end and a distal end opposite the proximal end, the proximal end attached to a periphery of the opening to form a first seal and the distal end attached to the at least part of the body of the spray device disposed in the interior of the booth to form a second seal.

21. The system of claim 20, wherein the boot element forms a conical shape tapering from a first diameter at the proximal end to a second diameter at the distal end, the first diameter being greater than the second diameter.

22. The system of claim 20, wherein the boot element forms a pyramidal shape tapering from a first width at the proximal end to a second width at the distal end, the first width being greater than the second width.

23. The system of claim 20, wherein at least one of the proximal end and the distal end of the boot element is configured to releasably attach, respectively, to the periphery of the opening or the body of the spray device.
